(19) United States
(12) Patent Application Publication
(10) Pub. No.: US 2008/0279429 A1
(43) Pub. Date: Nov. 13, 2008

(54) Method For Delineation of Predetermined Structures in 3D Images

(75) Inventors: Maxim Fradkin, Puteaux (FR); Jean-Michel Rouet, Paris (FR); Franck Laffargue, Poissy (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,765

(22) PCT Filed: Nov. 15, 2006
(86) PCT No.: PCT/IB06/54270

§ 371 Date: May 15, 2008

(30) Foreign Application Priority Data
Nov. 18, 2005 (EP) 05300941.1

(51) Int. Cl. G06T 5/00

(52) U.S. Cl. 382/128

(57) ABSTRACT

A method for delineating a bony structure within a 3D image of a body volume. A non contrast-enhanced tissue (reference) structure and a region comprising the bony structure and contrast-enhanced structures are identified (S2, S3) by thresholding or other image segmentation technique. A deformable model generally representative of the bony structure aligned and centred relative to the reference structure (S4) and the model is then deformed (S5) relative to the region of the image including the bony structure so as to fit the model thereto and thereby to delineate the bony structure in the image.

The invention relates to a system and method for delineation of predetermined structures, such as chest bones, within a 3D image with the purpose of enabling improved performance of visualisation and/or segmentation tasks. The 3D image may be generated, for example, during medical examinations, by means of x-ray computed tomography (CT), magnetic resonance (MR) or ultrasound (US) modalities.

In the field of medical imaging, various systems have been developed for generating medical images of various anatomical structures of individuals for the purposes of screening and evaluating medical conditions. For example, CT imaging systems can be used to obtain a set of cross-sectional images or two-dimensional (2D) “slices” of a region of interest (ROI) of a patient for the purposes of imaging organs and other anatomies. The CT modality is commonly employed for the purposes of diagnosing disease because such modality provides precise images that illustrate the size, shape and location of various anatomical structures such as organs, soft tissues and bones, and enables a more accurate evaluation of lesions and abnormal anatomical structures such as cancers, polyps, etc.

It is also very common for the practitioner to inject a contrast agent into the targeted organs, since such enhancement makes the organs easier to visualise or segment for quantitative measurements.

Large bony structures present in, for example, the thoracic region, like the ribs and spine, often distract the viewer and disturb segmentation and visualisation applications, such that segmentation and visualisation algorithms may operate incorrectly. A natural approach to overcoming this problem is to remove such bony structures from the image before proceeding to the examination. For example, International Patent Application No. WO 2004/111937 describes for this purpose a method of delineation of a structure of interest comprising fitting 3D deformable models to the boundaries of the structure of interest.

However, the above-mentioned injected contrast agent often causes the targeted organs to have a very similar image signature and this can prevent accurate “bone removal” from the image.

It is therefore an object of the present invention to provide an improved method of automatic delineation of predetermined structures in 3D images whereby said predetermined structures are distinguishable from other structures in the image having the same or similar image signatures.
In accordance with the present invention, there is provided a method for delineation of a predetermined structure in a three dimensional image of a body volume, the method comprising the steps of:
identifying a reference portion within said image;
identifying a region of interest within said image comprising all portions, including said predetermined structure, having substantially the same image signature as that of said predetermined structure;
positioning a deformable model representative of said predetermined structure relative to said reference portion within said image; and
performing a deformation process so as to fit said deformable model to said region of interest, thereby to delineate said predetermined structure therein.

Thus, using a known deformable model technique, anatomic prior knowledge can be efficiently expressed as an initial geometric model, vaguely resembling the predetermined structure to be extracted, wherein the deformation process to fit the model to a region in the image that includes the predetermined structure then enables the predetermined structure to be accurately delineated. If there are two structures with similar image signatures, one at least partially surrounding or covering the other, then according to the invention by using a deformable model, one of the structures can be segmented (either the interior structure or the exterior structure), and thus extracted without having to deal with the other one.

In one exemplary embodiment, e.g. if the reference image is a CT image, the reference portion and/or the region of interest may be identified by means of thresholding, wherein different grey level thresholds are employed to identify the reference portion and/or the region of interest respectively. However, other segmentation techniques will be known to a person skilled in the art, and the present invention is not necessarily intended to be limited in this regard. In an exemplary embodiment, the predetermined structure may comprise bones and the region of interest may include bones and one or more contrast-enhanced tissue structures.

In one exemplary embodiment, the deformable model comprises a mesh.

The present invention extends to an image processing device for performing delineation of a predetermined structure within a three-dimensional image of a body volume, the device comprising means for receiving image data in respect of said three-dimensional image and processing means configured to:
identify a reference portion within said image;
identify a region of interest within said image comprising all portions, including said
predetermined structure, having substantially the same image signature as that of said predetermined structure;
position a deformable model representative of said predetermined structure relative to said reference portion within said image; and
perform a deformation process so as to fit said deformable model to said region of interest, thereby to delineate said predetermined structure therein.

Preferably, the device further comprises means for extracting said predetermined structure thus delineated from said three-dimensional image for display. The image processing device may comprise a radiotherapy planning device, a radiotherapy device, a workstation, a computer or personal computer. In other words, the image processing device may be implemented with a workstation, computer or personal computer which are adapted accordingly. Also, the image processing device may be an integral part of a radiotherapy planning device, which is specially adapted, for example, for an MD to perform radiotherapy planning. For this, for example, the radiotherapy planning device may be adapted to acquire diagnosis data, such as CT images from a scanner. Also, the image processing device may be an integral part of a radiotherapy device. Such a radiotherapy device may comprise a source of radiation, which may be applied for both acquiring diagnostic data and applying radiation to the structure of interest.

Accordingly, according to exemplary embodiments of the present invention, processors or image processing devices which are adapted to perform the invention may be integrated or part of radiation therapy (planning) devices such as e.g. disclosed in WO 01/45562-A2 and U.S. Pat. No. 6,466,813.

The present invention extends still further to a software program for delineating a predetermined structure within a three-dimensional image of a body volume, wherein the software program causes a processor perform a method comprising the steps of:
identify a reference portion within said image;
identify a region of interest within said image comprising all portions, including
positioning a deformable model representative of said predetermined structure relative to said reference portion within said image; and
performing a deformation process so as to fit said deformable model to said region of interest, thereby to delineate said predetermined structure therein.

Thus, the above-mentioned object is achieved by providing a method of delineation of predetermined structures, such as bony structures (chest bones, ribs, etc.) in the thoracic region, within a 3D (e.g. CT) image using prior anatomic knowledge of the shape of the predetermined structure together with a deformable model technique, so as to enable such structures to be identified and extracted from the image fully automatically. This idea is based on the assumption that, in the case of a CT image of, say, the thoracic region, contrast-enhanced organs of interest are localised within the rib cage. Therefore, a deformable model starting (initialised) from outside the body and attracted to the bones will delineate only the rib cage and spine and not the inner, contrast-enhanced structures.

These and other aspects of the present invention will be apparent from, and elucidated with reference to the embodiments described herein.

Embodiments of the present invention will now be described by way of examples only and with reference to the accompanying drawings, in which:

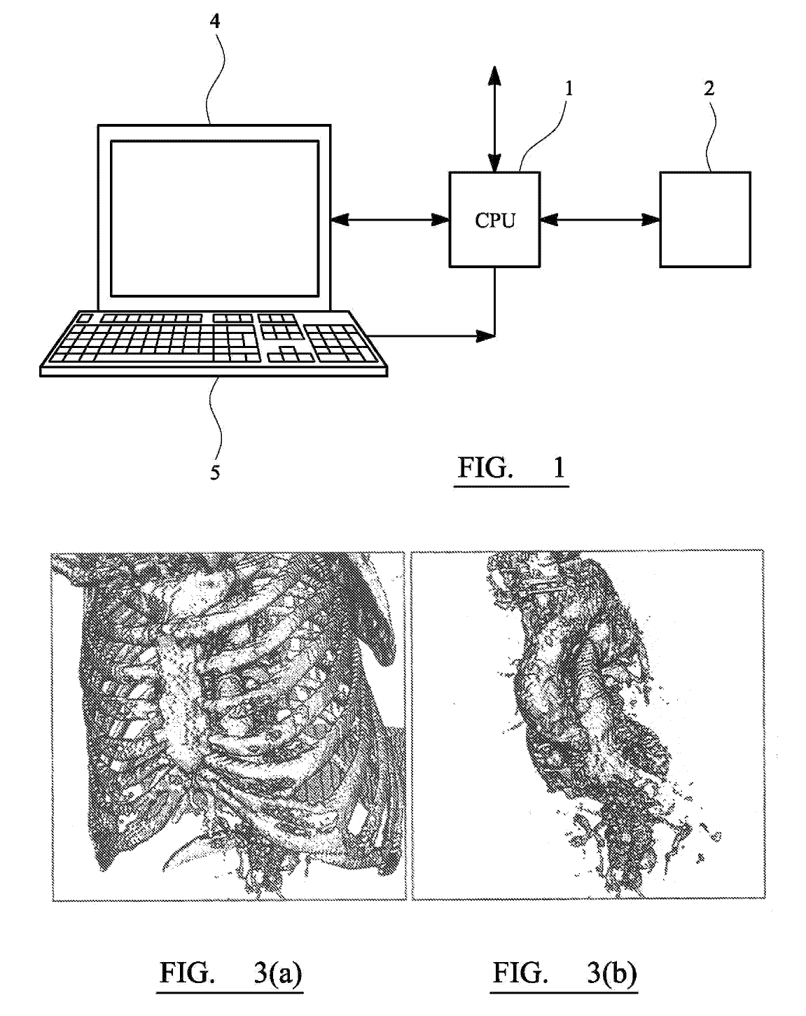

FIG. 1 shows a schematic representation of an image processing device according to an exemplary embodiment of the present invention, adapted to execute a method according to an exemplary embodiment of the present invention;

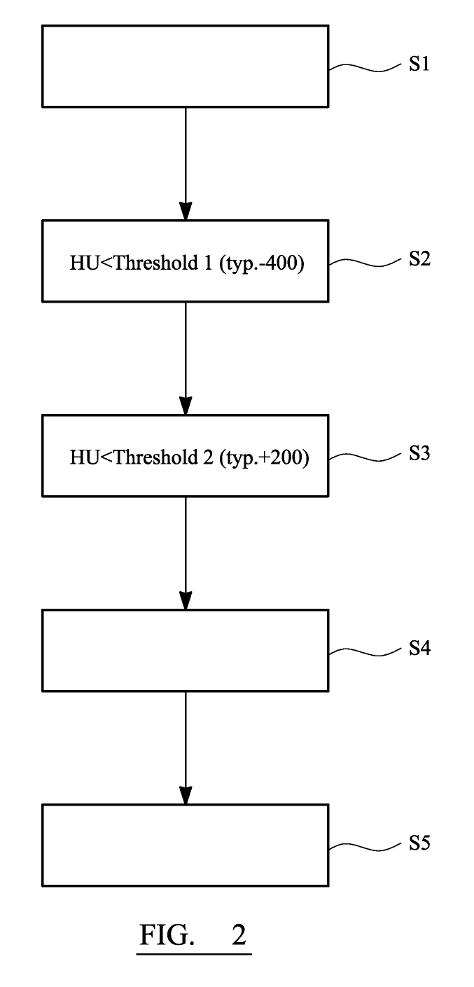

FIG. 2 is a schematic flow diagram illustrating the principal steps of a method according to an exemplary embodiment of the present invention; and

FIGS. 3a and 3b illustrate exemplary thresholded images of a thoracic region before (a) and after (b) removal of the chest bones and spine using a method according to an exemplary embodiment of the present invention.

FIG. 1 depicts an exemplary embodiment of an image processing device according to the present invention, for executing an exemplary embodiment of a method in accordance with the present invention. The image processing device depicted in FIG. 1 comprises a central processing unit (CPU) or image processor 1 connected to a memory 2 for storing at least one three dimensional image of a body volume, one or more deformable models of predetermined structures required to be delineated, and deformation parameters. The image processor 1 may be connected to a plurality of input/output network and diagnosis devices such as MR device or CT device, or an ultrasound scanner. The image processor 1 is furthermore connected to a display device 4 (for example, a computer monitor) for displaying information or images computed or adapted in the image processor 1. An operator may interact with the image processor 1 via a keyboard 5 and/or other input/output devices which are not depicted in FIG. 1.

Referring to FIG. 2 of the drawings, a flow diagram illustrating the principal steps of a method according to an exemplary embodiment of the present invention for delineation of a predetermined structure in a 3D image is shown. As a first step S1, a three-dimensional CT image is obtained of the thoracic region of a subject. Next, in step S2, a known image processing technique is applied to extract the lungs within the 3D image. CT images are quantitative in nature (i.e. the grey value of each voxel can be associated with a tissue type, e.g. bone, air, soft tissue), so the tissue portion (which is representative of the non contrast-enhanced lungs) can be identified using a relatively simple grey-level threshold [HU<Threshold1 (typ. −400)→Object1]. Similarly, in a third step S3, the bone and contrast-enhanced parts (which have a very similar image signature and, therefore, grey value to that of bone) can be extracted using a different grey-level threshold [HU<Threshold2 (typ. +200)→Object2].

At step S4, an initial (predefined) deformable anatomic model is automatically centred and aligned relative to the lungs (Object 1)→Mesh1 and, at step S5, Mesh1 is automatically fitted to Object2, using a coarse to fine deformation approach. In general, deformable models are a class of energy minimising surfaces that are controlled by an energy function. The energy function has two portions: internal energy and external energy. The internal energy characterises the energy of the surface due to elastic and bending deformations. The external energy is characterised by the image forces that attract the model toward image features such as edges.

The deformable model is usually represented by a mesh consisting of V vertices with coordinates xᵢ and N faces. To adapt the mesh to the structure of interest in the two-dimensional image, an iterative procedure is used, where each iteration consists of a surface detection step and a mesh deformation step. Mesh deformation is governed by a second order (Newtonian) evolution equation which can be rewritten for discrete meshes as follows:

$$m \frac{{\partial }^{2} {P}_{i}}{\partial {t}^{2}} = - γ \frac{\partial {P}_{i}}{\partial t} + α \cdot {E}_{int} + β \cdot {E}_{ext} \qquad ( 1 )$$

The external energy Eₑₓₜ drives the mesh towards the surface patches obtained in the surface detection step. The internal energy Eᵢₙₜ restricts the flexibility of the mesh. The parameters α and β weight the relative influence of each term, and γ stands for an inertia coefficient. This equation corresponds to equilibrium between inertial regularisation and data attraction forces. This equation can be discretised in time t, using an explicit discretisation scheme as follows:

xᵢ^{t+1}+xᵢ^{t}(1−γ)(xᵢ^{t}−xᵢ^{t-1})+α·Eᵢₙₜ+β·Eₑₓₜ (2)

The different components of the algorithm are now described in the following:

Surface Detection

For surface detection, a search is performed along a vertex normal nᵢ to find a point \ddot{x}ᵢ with the optimal combination of feature value Fᵢ(\ddot{x}ᵢ) and the distance δⱼ to the vertex xᵢ:

\ddot{x}ᵢ=xᵢ+nᵢδarg max{Fᵢ(xᵢ+nᵢδⱼ)−Dδ²j²}j=−1, . . . , l (3)

The parameter l defines the search profile length, the parameter δ is the distance between two successive points, and the parameter D controls the weighting of the distance information and the feature value. For example, the quantity

Fᵢ(x)=±nᵢ^{t}g(x) (4)

may be used as a feature, where g(x) denotes the image gradient at point x. The sign is chosen in dependence on the brightness of the structure of interest, with respect to the surrounding structures.

External Energy

In analogy to iterative closest point algorithms, the external energy for vertex Vi.

$${E}_{ext} = {\sum }_{i - l}^{T} {{w}_{i} ( {\tilde{x}}_{i} - {x}_{i} )}^{2} , \\ {w}_{i} = max \{ 0 , {F}_{i} ( {\tilde{x}}_{i} ) - {D ( {\tilde{x}}_{i} - {x}_{i} )}^{2} \} \qquad ( 5 )$$

may be used. As may be gathered from the above equation, the external energy is based on a distance between the deformable model and feature points, i.e. a boundary of the structure of interest.

Internal Energy

The regularity of the surface is only controlled by the simplex angle φ of each vertex. The simplex angle codes the elevation of a vertex with respect to the plane defined by its three neighbours. The internal force has the following expression:

F_{int i}=x*ᵢ−xᵢ (6)

where x*ᵢ is the point towards which the current vertex position is dragged under the influence of internal forces. Different types of internal forces can therefore be designed, depending on the condition set on the simplex angle of such a point. Furthermore, we usually set the metric parameters of such a point such that its projection onto the neighbours' plane is the isocenter of the neighbours.

The mesh evolution is then performed by its iterative deformation of its vertices using equation (2).

H. Delingette, “Simplex Meshes: A General Representation for 3D Shape Reconstruction” in the Proc. of the International Conference on Computer Vision and Pattern Recognition. (CPVR '94), 20-24 Jun. 1994, Seattle, USA, which is hereby incorporated by reference.

Finally, at step S5, the bone structures (from Object2) that are located to a given extent within Mesh2 are extracted from the image→Object3.

Thus, in the exemplary method set forth above, steps S1, S2 and S5 comprise basic image processing techniques. Steps S3 and S4 entail the use of commonly used discrete deformable models, such as, for example, those described above. Using a deformable model technique, anatomic prior knowledge can be efficiently expressed as an initial geometric model, vaguely resembling the structures to be extracted (e.g. rib cage and spine in this case), and suitable deformation parameters (i.e. very rigid model, shape preserving global deformation).

Exemplary thresholded images before (a) and after (b) bone removal are illustrated in FIG. 3. In FIG. 3b, the contrast-enhanced structures can be clearly seen, whereas they are largely hidden from view in the image of FIG. 3a.
It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method for delineation of a predetermined structure in a three dimensional image of a body volume, the method comprising the steps of:
identifying a reference portion within said image;
identifying a region of interest within said image comprising all portions, including said predetermined structure, having substantially the same image signature as that of said predetermined structure;
positioning a deformable model representative of said predetermined structure relative to said reference portion within said image; and
performing a deformation process so as to fit said deformable model to said region of interest, thereby to delineate said predetermined structure therein.

2. A method according to claim 1, wherein the deformable model comprises a mesh.

3. An image processing device for performing delineation of a predetermined structure within a three-dimensional image of a body volume, the device comprising means for receiving image data in respect of said three-dimensional image and processing means configured to:
identify a reference portion within said image;
identify (53) a region of interest within said image comprising all portions,
including said predetermined structure, having substantially the same image signature as that of said predetermined structure;
position a deformable model representative of said predetermined structure relative to said reference portion within said image; and
perform a deformation process so as to fit said deformable model to said region of interest, thereby to delineate said predetermined structure therein.

4. A device according to claim 3, further comprising means for extracting said predetermined structure thus delineated from said three-dimensional image for display.

5. A software program for delineating a predetermined structure within a three-dimensional image of a body volume, wherein the software program causes a process or perform a method comprising the steps of:
identifying a reference portion within said image;
identifying a region of interest within said image comprising all portions, including said predetermined structure, having substantially the same image signature as that of said predetermined structure;
positioning a deformable model representative of said predetermined structure relative to said reference portion within said image; and
performing a deformation process so as to fit said deformable model to said region of interest, thereby to delineate said predetermined structure therein.
